(19) United States
(12) Patent Application Publication
(10) Pub. No.: US 2023/0344782 A1
(43) Pub. Date: Oct. 26, 2023

(54) METHOD FOR A CONFIGURATION IN A NETWORK

(71) Applicant: Robert Bosch GmbH, Stuttgart (DE)

(72) Inventors: Dakshina Narahari Dasari, Boeblingen (DE); Michael Pressler, Karlsruhe (DE); Naresh Ganesh Nayak, Leonberg (DE)

(21) Appl. No.: 18/185,047

(22) Filed: Mar. 16, 2023

(30) Foreign Application Priority Data
Apr. 22, 2022 (DE) 10 2022 203 945.9

(51) Int. Cl. H04L 47/70; H04L 65/40

(52) U.S. Cl. CPC H04L 47/821; H04L 65/40

(57) ABSTRACT

A method for a configuration in a network. The method includes the following steps for at least one real-time application, the real-time application including multiple tasks chained in the network: receiving at least one message unit from a preceding task of the real-time application; ascertaining an execution time of the preceding task based on the message unit received; evaluating the ascertained execution time, which includes at least one comparison of the ascertained execution time to at least one time allowance, to thereby determine an instantaneous slack of the real-time application, prioritizing the message unit based on the ascertained slack and forwarding the message unit in the network as a function of the prioritization to a following task of the real-time application.

### CROSS REFERENCE

The present application claims the benefit under 35 U.S.C. § 119 of German Patent Application No. DE 10 2022 203 945.9 filed on Apr. 22, 2022, which is expressly incorporated herein by reference in its entirety.

### FIELD

The present invention relates to a method for a configuration in a network. The present invention also relates to a computer program, a module as well as a system, each for this purpose.

### BACKGROUND INFORMATION

In the related art, real-time-critical applications may be provided on a distributed system. In that case, the tasks of the applications may be executed by various computing nodes. The tasks are in a daisy chain, in order to make an application available in coordinated fashion. For example, an application may be provided by way of sensor tasks, processing tasks and activation tasks, in which one of the tasks is provided for reading sensor values, the sensor values are subsequently passed on to further tasks which process this data and based on that, are able to carry out a control.

In order to provide real-time-critical applications, in addition, end-to-end latencies may be provided as time allowances of applications or their event chain. In the case of real-time applications, it is required that an application must be run within a specific time and a result of the application must be made available. This specific time may be referred to as the end-to-end latency, thus, as the interval between a point in time at which an input is received by a first task of the chain, up to the point in time at which the end result of the application is output. Sufficient guarantee of the end-to-end latency is crucial in various areas. Thus, for example, automotive systems with newer functions such as assisted driving are becoming increasingly complex. Many of these automotive applications usually have stringent real-time requirements—it is not only important that a calculation result be correct, but also that the result be presented at the proper time.

### SUMMARY

The present invention provides a method, a computer program, a module, and a system having the features set forth in claim 11. Features and details of example embodiments of the present invention are disclosed herein. In this context, features and details which are described in connection with the method of the present invention naturally also pertain in connection with the computer program of the present invention, the module of the present invention as well as the system of the present invention and vice versa, so that with respect to the disclosure, mutual reference is made or may be made constantly to the individual aspects of the present invention.

The method is used for the configuration, especially the dynamic configuration, in a network. The network is able to run at least one or more real-time applications, which in turn may include multiple tasks chained in the network. The tasks may be chained, since a preceding task produces a result which must be handed over to a following task, allowing the real-time application to be executed correctly. For the handover, a communication may be carried out via the network between different nodes, preferably computing nodes, of the network, the handover or communication being able to be accomplished via message units such as data packets. Correspondingly, the tasks may also be performed in different nodes, e.g., individual computers, so that a data-processing environment is provided in the form of a distributed system for the real-time applications.

Hereinafter, the real-time applications are also referred to as applications for short. The term real-time may refer to the fact that the applications must deliver their result within a predetermined time. For real-time-critical applications, it is therefore often necessary to ensure that a specific end-to-end requirement is satisfied. This is understood to be a latency or maximum delay of the execution, by when a result of the application must thus be available at the latest. At the same time, this requirement also affects the chained tasks. Each of the tasks is a part of the overall real-time application, so that their successful execution is a prerequisite for the correct execution of the overall real-time application. In this context, the execution times of the individual tasks (co-)determine in sum the total execution time of the overall real-time application. Therefore, the configuration in the network, e.g., in terms of a prioritization of the communication is often of great importance for the guarantee of the real-time execution.

The steps provided in the method of the present invention for the configuration in a network, also referred to as configuration steps, for the at least one real-time application may preferably be carried out one after the other in the order indicated below. In addition, it is possible that the steps are carried out repeatedly during a runtime of the real-time applications and/or are also carried out for further real-time applications and/or optionally, are carried out in completely automated fashion. In this context, according to an example embodiment of the present invention, the steps, specifically configuration steps, may include:
Receiving at least one message unit such as a data packet from a preceding task of the real-time application,
Ascertaining, e.g., calculating an execution time of the preceding task based on the message unit received, for example, based on time information of the message unit about a starting time of the preceding task or of the real-time application,
Evaluating the ascertained execution time, which includes at least one comparison of the ascertained execution time to at least one, especially predefined or previously calculated time allowance, to thereby determine an instantaneous time margin of the real-time application,
Prioritizing the message unit based on the ascertained time margin and forwarding the message unit in the network as a function of the prioritization to a following task of the real-time application, the configuration in the network thereby preferably being accomplished, particularly dynamically, based on the ascertained time margin.

As a result, the method has the advantage of a dynamic—that is, non-static—prioritization and configuration in the network. Consequently, a configuration is thus understood to mean in particular that prioritized message units are forwarded in the network, thus, the forwarding may be configured and therefore adapted as a function of the prioritization, and the prioritization may be a function of the ascertained time margin. Traditionally, one possibility for the prioritization of applications in the network may be a static prioritization. In that case, the application priority would be transferred statically and uniformly to the communication of the application, thus, for example, the associated data packets. However, a recognition within the framework of the present invention is that such a static priority may be disadvantageous, since it does not take into account the time margin in the task chains. As a result, data packets for applications with low priority may be at a disadvantage and delayed unnecessarily, even if applications with higher priority have sufficient time margin to be finished in time. Moreover, a static prioritization would also be agnostic with respect to parameters that, if necessary, may be taken into account for the prioritization in the method according to the invention, such as with respect to the transmission variability because of uncertainties in the network and with respect to the execution variability because of exceeding or falling short of the execution time of the tasks.

For example, the prioritization is accomplished by marking the at least one message unit. To that end, for instance, a priority field is determined in a header of the message unit. Accordingly, the message unit may include the header with metadata, and the payload with the actual message, thus, e.g., the result of the preceding task. The priority field may then be read out by the interposed switches/routers of the network in order to decide about the order of the transmission of the message units.

A time margin is understood particularly as a “slack”, from which, for example, it is possible to infer a time reserve for the application. In other words, the slack may denote the time reserve which a real-time application still has for fulfilling its real-time requirement. For example, each task of the real-time application may be assigned an upper limit for its execution time, which must be honored in order to fulfill the real-time requirement. The slack may then be defined by the difference between the actual execution times and the upper limits of the tasks of the real-time application. The real-time requirement may also be referred to as end-to-end requirement.

The respective upper limits of the tasks may be defined by the time allowance mentioned above. In this regard, one may speak of a local time allowance which defines the upper limits. The real-time requirement of an overall real-time application may also be defined by the time allowance, namely, as a global time allowance. This may define a point in time by which all tasks of the application must be performed. Derived from the global time allowance, it is then possible to dynamically calculate the local time allowances for the tasks, as described in greater detail below.

The real-time application may advantageously be a first real-time application of at least two real-time applications distributed in the network, the real-time applications and specifically also their tasks being able to be carried out at least partially in parallel. In this connection, one may also speak of a distributed system of real-time applications.

According to an example embodiment of the present invention, it is likewise possible that the evaluation of the ascertained execution time also includes:
Carrying out a further comparison of the ascertained slack of the first real-time application to an instantaneous slack of a second real-time application, in order to determine a comparison result via the slacks of the real-time applications.

In addition, according to an example embodiment of the present invention, the prioritization may be carried out as a function of the comparison result, in order to forward the message unit with higher priority in the network if the slack of the first real-time application is less than the slack of the second real-time application. Conversely, the comparison result may also be utilized for the forwarding of a message unit of the second real-time application in order to pass it on with higher priority if the slack of the first real-time application is greater than the slack of the second real-time application. Consequently, the prioritization may be implemented reliably on the basis of the slack. The configuration steps may thus also be carried out in parallel for further or the second real-time application(s) in order, for example, to thereby determine the instantaneous slack of the second real-time application, as well.

In addition, it is advantageous if the prioritization is implemented, moreover, depending on at least one of the following criteria:
a structure of the chaining of the tasks such as, e.g., information about the delays, thus latencies, owing to the communication between the tasks,
a function of the real-time applications such as a prioritization of the function in comparison to the further real-time applications,
a relevance of the real-time-critical execution of the real-time applications, e.g., as a categorization in different relevance levels,
a safety relevance of the real-time applications, e.g., for identifying real-time applications particularly critical in terms of safety,
a static prioritization of the real-time applications, which optionally, may also be used for the dynamic prioritization and was defined prior to a runtime of the real-time applications.

An especially dynamic and many-sided prioritization is thereby possible.

A further advantage may be attained if the at least one time allowance includes a local time allowance which defines an upper limit for the execution time of the individual task. Moreover, it is possible that the real-time application is a first real-time application of at least two real-time applications distributed in the network, it being possible to predefine a global time allowance for each of the real-time applications, which in each case defines an upper limit for a total execution time of the specific real-time application. In that case, prior to the evaluation, the following step may be carried out:
Determining the local time allowance on the basis of the global time allowance of the first real-time application and/or on the basis of a structure of the chained tasks of the first real-time application,
   the prioritization being carried out in order to adhere to the global time allowance for each real-time application.

“Local” may refer here to “task-specific”, in contrast to global, thus, application-specific. In addition to the individual time requirements for the response times of the tasks (that is, the local time allowance may correspond to the response time of the task), the real-time applications often also have time requirements for the end-to-end latency of the task chains, also referred to here as global time allowance. For each task which belongs to a real-time application having a preset global time allowance, a local time allowance may be derived, by which each task of the application must be completed in order for the application to be able to adhere to its real-time requirement. If necessary, information about a structure of the chained tasks may be utilized for that purpose. For example, the structure also includes information about the computing intensity or maximum calculation duration or the like of the tasks. If applicable, the local time allowances may be communicated to all further tasks of the real-time application. For instance, this may be achieved by standard graph algorithms such as list scheduling, in which the latest start time of each node may be defined.

In addition, the steps of the method, that is, the configuration steps may be carried out for at least two or at least three or at least four further real-time applications in the network, the respective message units being forwarded dynamically as a function of the prioritization based on the respective slacks, particularly to thus dynamically configure the forwarding of the respective message units. For example, message units with a higher priority may be forwarded faster than message units with a lower priority. Thus, an extensive system of real-time applications may be dynamically and reliably configured, as well.

It is possible that the steps of the method, that is, the configuration steps for the real-time applications are in each case carried out by a network configurator. Preferably, the chained tasks of the real-time applications may be performed in different nodes of the network, and the steps for the real-time applications may be carried out at each of the nodes by the network configurator. For example, the network configurator may be provided by a software and/or hardware module, which is provided accordingly in the individual nodes. This has the advantage that the prioritization may be provided in decentralized fashion with reduced expenditure. This also allows the network configurator to call for the local time allowances of the individual tasks. Thus, whenever a task is completed at a particular node, the corresponding network configurator at this node is able to check whether the task is ahead of or behind the schedule of the time allowance, by comparing the execution time to the local time allowance. In order to quantify this, the network configurator may calculate the slack that is obtained from the difference between the local time allowance and the execution time. A smaller slack means thus that the deadline according to the global time allowance of the application is approaching sooner and therefore the priority of the message unit is increased. A slack of less than 0 means that the task could not honor its local time allowance.

Moreover, It is possible that the network includes different routes between the nodes, the prioritization making it possible to decide over which of the routes the message unit is forwarded in order to arrive at one of the nodes. Thus, the forwarding may be carried out as a function of the prioritization based on the respective slacks. In addition, each of the message units may take the form of a data packet and/or each of the nodes may take the form of a computing node for executing the tasks. The chained tasks may also be referred to as task chain, as they are often represented in an application graph. The task chains may be found both in single-node and in distributed real-time systems. The execution time may be normalized over heterogeneous nodes, if the nodes have different clock frequencies or architectures.

For example, the real-time applications may be parts of a middleware (e.g., for a vehicle operating system or a vehicle function) and/or of a vehicle operating system and/or of an autonomous driving function and/or of a programmable controller, preferably at least one of the tasks of a real-time application being performed to acquire sensor values, at least another of the tasks of the real-time application being performed to process the acquired sensor values and at least one other of the tasks of the real-time application being performed to control a machine on the basis of the processing. For instance, an application for autonomous driving may typically be subdivided into the functions of perception (sensor system), path planning (processing) and actuating functions, thus, the control, with specific requirements of the end-to-end latency of the application. Besides the automotive sector, the need for distributed real-time guarantees is also encountered in avionics as well as in plant and factory systems.

A computer program is likewise a subject matter of the present invention, particularly a computer-program product, including commands which, upon the execution of the computer program by a computer, prompt it to carry out the method of the present invention. Consequently, the computer program of the present invention brings along with it the same advantages as have been described in detail with reference to a method of the present invention.

As the computer, a node of the network may be provided, for example, which runs the computer program, e.g., in the form of a software module and/or network configurator. The computer may have at least one processor for executing the computer program. A non-volatile data memory may also be provided, in which the computer program is stored and from which the processor is able to read out the computer program for execution.

A machine-readable storage medium, which includes the computer program of the present invention, may likewise be a subject matter of the present invention. For instance, the storage medium takes the form of a data memory such as a hard disk and/or a non-volatile memory and/or a memory card. For example, the storage medium may be integrated in at least one or every node of the network.

Also a subject matter of the present invention is a module, particularly a network configurator, for a configuration in a network, which is equipped to carry out the method according to the invention. Consequently, the module of the present invention brings along with it the same advantages as have been described in detail with reference to a method of the present invention.

A system is likewise a subject matter of the present invention, having:
a network for executing real-time applications, the real-time applications in each case including multiple chained tasks, which are performed in different nodes of the network.

In this connection, a module according to the present invention is provided specifically at each of the different nodes, in order to dynamically implement the configuration for the execution of the real-time applications. Consequently, the system of the present invention brings along with it the same advantages as have been described in detail with reference to a method of the present invention.

In addition, the method of the present invention may also be realized as a computer-implemented method.

Further advantages, features and particulars of the present invention are derived from the following description, in which exemplary embodiments of the invention are described in detail with reference to the figures. In this context, each of the features mentioned herein may be essential to the present invention individually on its own or in any combination.

### BRIEF DESCRIPTION OF THE DRAWINGS

FIG. 1 shows a method according to an example embodiment of the present invention in a schematic representation,

FIG. 2 shows a method according to an example embodiment of the present invention in a further schematic representation.

FIG. 3 shows schematically a system and module of an example embodiment of the present invention.

In the following figures, the identical reference numerals are used for the same technical features, even of different exemplary embodiments.

### DETAILED DESCRIPTION OF EXAMPLE EMBODIMENTS

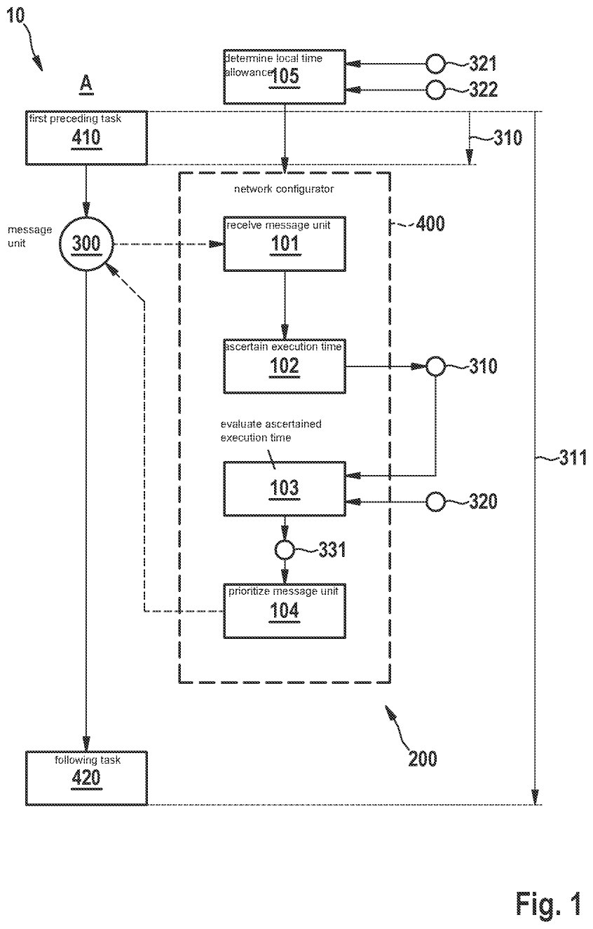

FIG. 1 illustrates a method according to the present invention for a configuration in a network 10 of distributed real-time applications, (shown by way of example with real-time application

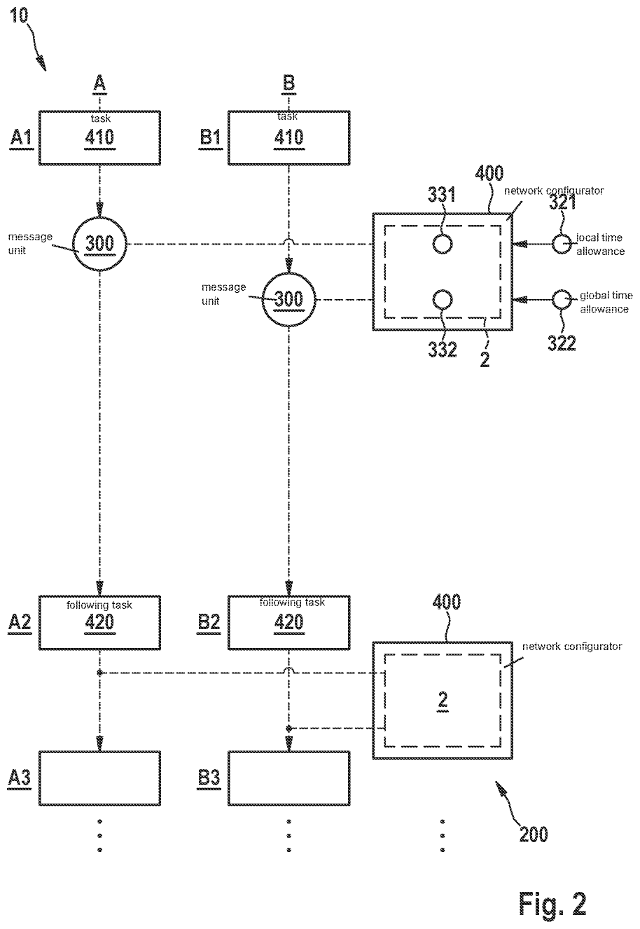

A). Supplementary to this, FIG. 2 shows method steps 101-104 of this method with further details.

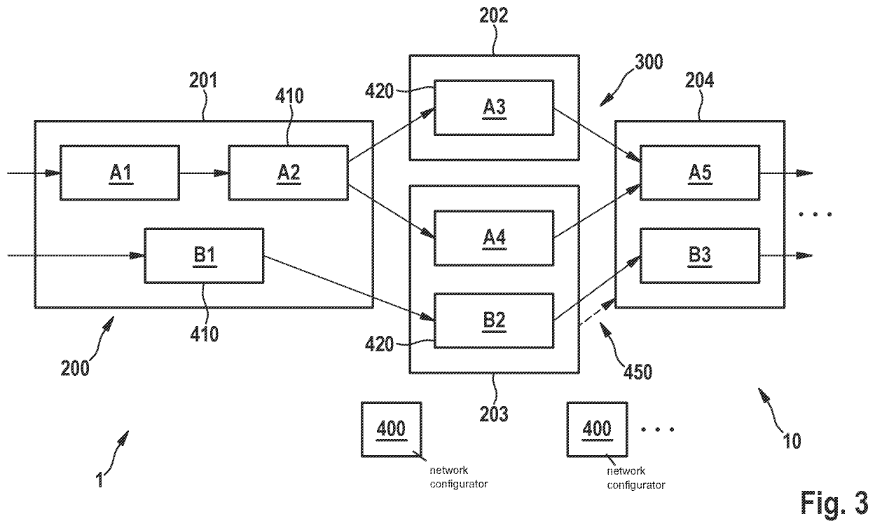

In addition, FIG. 3 shows an exemplary embodiment in which real-time applications A, B are made available via a distributed system 1. Applications A and B may each be realized by task chains. As an example, in FIG. 3, these chained tasks are distributed to various computing nodes 201-204 in network 10. Application A here includes tasks A1-A5, while application B includes tasks B1-B3. It is discernible that tasks A3 and A4 are provided as parallel tasks of real-time application A, and therefore are performed at least partially overlapping in time. Tasks A1 and A2, on the other hand, are tasks executed sequentially.

Both real-time applications A and B may be assigned a different (static) priority and/or an end-to-end requirement. For time-critical applications, it must often be ensured that they satisfy their end-to-end requirements. This may make it necessary that both the computing and the network resource managers take the priority and the QoS (Quality of Service) requirements of these applications into account. There are specific solutions such as “Reservation-based Scheduling” for reserving computing capacities in the processor kernels of nodes. They usually act on the level of the tasks. Similar network-reservation protocols are likewise known, which deal with the QoS on the packet level. However, these known mechanisms do not deal with task chains and do not take the end-to-end requirements into account.

Therefore, a mechanism is advantageous which does not, or does not only statically consider the priorities of the individual tasks, but rather takes into account the instantaneous completion status and therefore the slack of applications A, B, in order to ensure that the end-to-end requirements are honored. Therefore, a dynamic configuration in network 10 is proposed by way of steps of the method, which may be carried out particularly by a network configurator 400 at respective nodes 201-204.

These steps 101-104 and the function of network configurator 400 are illustrated by way of example in FIG. 1 on the basis of a real-time application A. In this context, the entire processing of real-time application A may be subdivided into multiple tasks that are chained together and therefore also communicating with each other. In the following, a state is assumed in which a first preceding task 410 of this chain is completed and its processing result is made available by a message unit 300 such as a data packet. This message unit 300 is intended to be transmitted to a following task 420. Following task 420 may use and assume the processing result, in order to calculate a further processing result, so that real-time application A is completely executed successively by the tasks. In particular, the forwarding of message units 300 of this and further real-time applications A, B between different tasks in different nodes 200 may be carried out in a manner prioritized not (only) statically, but (also) dynamically, in order to ensure faster processing, but also a fulfillment of the real-time requirements.

Accordingly, the priority may be assigned not, or not only, on the basis of static parameters, but rather may take into account a time allowance 320 of real-time application A and its instantaneous execution status. In this case, time allowance 320 may be a deadline, thus may define a point in time by which the application must have produced a result at the latest. Accordingly, the prioritization may take into account, inter alia, an execution time 310 of a task as well as the time remaining until this point in time. Moreover, at each node 200, the variability of execution time 310 on the processor of node 200 and the transmission delays of message units 300, which come from the predecessor nodes, may also be considered in the dynamic assignment of the priority. These together may define a slack 331.

The method first of all may include receiving 101 of message unit 300 from preceding task 410 of real-time application A, e.g., by way of a network interface, not explicitly shown, of a node 200. In this context, if applicable, respective network configurator 400 may intercept all messages which are sent or received by the network interface of each node. Network configurator 400 may thus be responsible for determining the priorities of message units 300, especially packets, before they get into the network. All tasks may therefore transmit their message units 300 via network configurator 400. Execution time 310 of preceding task 410 may then be ascertained 102 based on message unit 300 received. After that, ascertained execution time 310 may be evaluated 103, evaluation 103 including at least one comparison of ascertained execution time 310 to time allowance 320 for this task 410, to thereby determine an instantaneous slack 331 of real-time application A. In a subsequent step, message unit 300 may be prioritized 104 based on ascertained slack 331, and this prioritized message unit 300 may be forwarded as a function of the prioritization in network 10 to following task 420 of real-time application A. In this way, the configuration in the network may take place dynamically on the basis of ascertained slack 331. In other words, message unit 300 is configured in such a way that the subsequent forwarding is carried out according to the assigned priority. For example, this may be accomplished by an identification of message unit 300. Message units 300 with a higher priority may be forwarded faster, for instance, than message units 300 with a lower priority.

FIG. 2 shows that real-time application A may be a first real-time application A of at least two real-time applications A, B distributed in network 10, real-time applications A, B being executed at least partially in parallel. It is possible that both real-time applications A, B together are taken into account in the prioritization. Thus, evaluation 103 of ascertained execution time 310 may also include carrying out a further comparison of ascertained slack 331 of real-time application A to an instantaneous slack 332 of second real-time application B, in order to determine a comparison result via slacks 331, 332 of real-time applications A, B. Optionally, instantaneous slack 332 of second real-time application B may likewise be determined by a further execution of the steps of the method. Prioritization 104 may then be carried out as a function of the comparison result, in order to forward message unit 300 of first real-time application A with higher priority in network 10 if slack 331 of first real-time application A is less than slack 332 of second real-time application B. Conversely, message unit 300 of first real-time application A may be forwarded with lower priority in network 10 if slack 331 of first real-time application A is greater than slack 332 of second real-time application B. Therefore, based on the comparison result, it is possible to decide which of message units 300 of real-time applications A, B is forwarded first.

FIG. 1 shows that individual task 410 (just like further tasks 410, 420 of a real-time application A, B) has a certain execution time 310 which may vary during the runtime of real-time applications A, B. Real-time application A may also have an overall execution time 311, which likewise varies as a function of execution times 310 of individual tasks 410, 420, but also possibly as a function of further factors such as transmission delays and variability of the execution time on the processor. In order to provide the real-time capability, an upper limit must be provided, however, for respective execution times 310. Time allowance 320 is provided for this purpose. Time allowance 320 may include a local time allowance 321, which defines an upper limit for execution time 310 of individual task 410. In addition, for each of real-time applications A, B, a global time allowance 322 may be predefined in the sense of an end-to-end requirement, which in each case defines an upper limit for overall execution time 311 of respective real-time application A, B. Prior to evaluation 103, the further step may be provided of determining 105 local time allowance 321 on the basis of global time allowance 322 of real-time applications A, B and/or on the basis of a structure of chained tasks 410, 420 and/or on the basis of predefined requirements of real-time applications A, B. For example, in order to determine local time allowance 321, global time allowance 322 may be divided by the number of tasks of corresponding real-time application A, B. Or a structure of chained tasks 410, 420 may be predefined, by which different tasks are weighted differently, so that local time allowances 321 are apportioned according to the weighting. In this way, prioritization 104 may be carried out so that global time allowance 322 is honored for each real-time application A, B.

FIG. 3 shows by way of example a distributed system of real-time-critical applications A, B. The illustration is in the form of a graph in which the corner points represent tasks 410, 420 and the edges between the corner points represent the communication between the different corner points. It is shown that the steps for real-time applications A, B may be carried out at each of nodes 201-204 by a network configurator 400. It is also possible that network 10 includes different (alternative) routes 450 between nodes 201-204 (represented schematically by a dash-lined arrow). Prioritization 104 may then be used to decide via which of routes 450 message unit 300 is passed on in order to arrive at one of nodes 201-204. In the case of higher priority, a route with better transmission performance may be selected accordingly. Thus, for example, the routes may each have different characteristics (e.g., latency, available bandwidth, etc.). The route via which a message unit 300 is to be transmitted may be determined by identifiers (e.g., VLANs, MPLS, etc.) which could be inserted by prioritization 104 at runtime. It should be pointed out that the identifiers do not necessarily have to lead to different physical routes (i.e., different connections). The identifiers may also merely imply the allocation of network resources (latency and bandwidth) and the prioritization of message units 300, but also do not rule out the use of different physical routes. Such an identifier-based handling of message units 300 may be made possible using network technologies such as Time-Sensitive Networking (TSN).

The steps shall be further explained by way of example with the aid of FIG. 3. Thus, as an example, application A may be assigned a global time allowance of 20 units of time as of the receipt of the first input of application A, while application B was assigned a global time allowance of 18 units of time. Each task in application A, B may cost a certain execution time, but the communication between nodes 201-204 may also bring about costs, which by way of example, are in each case assumed with 1. In this context, the costs for the communication within nodes 201-204 are possibly negligible. One task now may be to prioritize message units 300 in network 10 so as to ensure that applications A, B adhere to their end-to-end requirements. Therefore, according to FIG. 1, first of all local time allowance 321 may be calculated for each task by network configurator 400 and global time allowance 322 of application A, B may be taken into account in so doing. Since as an example, global time allowance 322 of application A amounts to 20, task A5 may be completed no later than at time 20 relative to the receipt of the input, while A3 may be finished no later than 20−3−1=16, so that application A adheres to its time allowance. In this case, cost value 1 for the communication between nodes 202 and 203 and the execution time of A5 with 3 units of time are taken into account.

According to a further example, network configurator 400 in node 203 may receive two different message units 300 from tasks A4 and B2 at a specific point in time. In order to mark message units 300 with the correct priority, network configurator 400 may first of all ascertain instantaneous slack 331 of applications A, B. For instance, task A4 was completed at point in time 15, but has a local time allowance 321 of 16, while task B2 was completed punctually at point in time 13 and has a local time allowance 321 of 13. This means that application A has a slack 331 of 1 unit of time, while application B has a slack 331 of 0. With this information, network configurator 400 in node 203 decides to grant a higher priority to message unit 300 of application B, since it has a smaller slack 331, that is, a greater risk of failing to meet global time allowance 322.

FIG. 2 shows that network configurator 400 may take the form of a module 400, such as a software module, which is realized by a node 201-204. Correspondingly, network configurator 400 may also have a computer program 2, including commands which, upon execution of computer program 2 by a computer 200 such as nodes 201-204, prompt it to carry out the method according to the present invention.

The explanation of the specific embodiments above describes the present invention exclusively within the context of examples. Naturally, insofar as technically reasonable, individual features of the specific embodiments may be freely combined with each other without departing from the scope of the present invention.

What is claimed is:

1. A method for a configuration in a network, at least one real-time application including multiple tasks chained in the network, the method comprising the following steps for the at least one real-time application:
receiving at least one message unit from a preceding task of the real-time application;
ascertaining an execution time of the preceding task based on the message unit received;
evaluating the ascertained execution time, the evaluating including at least one comparison of the ascertained execution time to at least one time allowance, to determine an instantaneous slack of the real-time application;
prioritizing the message unit based on the ascertained slack and forwarding the message unit in the network as a function of the prioritization to a following task of the real-time application.

2. The method as recited in claim 1, wherein the real-time application is a first real-time application of at least two real-time applications distributed in the network, the at least two real-time applications being executed at least partially in parallel, the evaluating of the ascertained execution time further including:
carrying out a further comparison of the ascertained slack of the first real-time application to an instantaneous slack of a second real-time application of the real-time applications, to determine a comparison result via the slacks of the real-time applications;
wherein the prioritization is carried out as a function of the comparison result, to forward the message unit with higher priority in the network when the slack of the first real-time application is less than the slack of the second real-time application.

3. The method as recited in claim 1, wherein the prioritization is also carried out depending on at least one of the following criteria:
a structure of the chaining of the tasks,
a function of the real-time applications,
a relevance of the real-time-critical execution of the real-time applications,
a safety relevance of the real-time applications,
a static prioritization of the real-time applications.

4. The method as recited in claim 1, wherein the at least one time allowance includes a local time allowance which defines an upper limit for the execution time of an individual task, the real-time application being a first real-time application of at least two real-time applications distributed in the network, wherein, for each respective real-time application of the real-time applications, a global time allowance is predefined which each defines an upper limit for an overall execution time of the respective real-time application, and prior to the evaluation, the following step being carried out:
determining the local time allowance based on the global time allowance of the first real-time application and based on a structure of the chained tasks of the first real-time application, the prioritization being carried out in order to honor the global time allowance for each respective real-time application.

5. The method as recited in claim 1, wherein the steps of the method are carried out for at least two further real-time applications in the network, the respective message units being forwarded dynamically as a function of the prioritization based on the respective slacks.

6. The method as recited in claim 5, wherein the chained tasks of the real-time applications are executed in different nodes of the network, and the steps of the method for the real-time applications are carried out at each of the nodes by a network configurator.

7. The method as recited in claim 6, wherein the network includes different routes between the nodes, it being decided by the prioritization, via which of the routes the message unit is forwarded in order to arrive at one of the nodes, each of the message units in in the form of a data packet and each of the nodes is in the form of a computing node for executing the tasks.

8. The method as recited in claim 2, wherein the real-time applications are parts of a middleware and/or of a vehicle operating system and/or of an autonomous driving function and/or of a programmable controller, at least one of the tasks of a real-time application of the real-time applications being performed to acquire sensor values, at least another of the tasks of the real-time application being performed to process the acquired sensor values and at least one other of the tasks of the real-time application being performed to control a machine based on the processing.

9. A non-transitory computer-readable medium on which is stored a computer program including commands for a configuration in a network, at least one real-time application including multiple tasks chained in the network, the commands, when executed by a computer, causing the computer to perform the following steps for the at least one real-time application:
receiving at least one message unit from a preceding task of the real-time application;
ascertaining an execution time of the preceding task based on the message unit received;
evaluating the ascertained execution time, the evaluating including at least one comparison of the ascertained execution time to at least one time allowance, to determine an instantaneous slack of the real-time application;
prioritizing the message unit based on the ascertained slack and forwarding the message unit in the network as a function of the prioritization to a following task of the real-time application.

10. A module for a configuration in a network, at least one real-time application including multiple tasks chained in the network, the module configured to, for the at least one real-time application:
receive at least one message unit from a preceding task of the real-time application;
ascertain an execution time of the preceding task based on the message unit received;
evaluate the ascertained execution time, the evaluating including at least one comparison of the ascertained execution time to at least one time allowance, to determine an instantaneous slack of the real-time application;
prioritize the message unit based on the ascertained slack and forward the message unit in the network as a function of the prioritization to a following task of the real-time application.

11. A system, comprising:
a network configured to execute real-time applications, each of the real-time applications including multiple chained tasks, which are performed in different nodes of the network, wherein a module is provided at the different nodes, to implement configuration dynamically for execution of the real-time applications, the module the module configured to, for each real-time application of the real-time applications:
receive at least one message unit from a preceding task of the real-time application;
ascertain an execution time of the preceding task based on the message unit received;
evaluate the ascertained execution time, the evaluating including at least one comparison of the ascertained execution time to at least one time allowance, to determine an instantaneous slack of the real-time application;
prioritize the message unit based on the ascertained slack and forward the message unit in the network as a function of the prioritization to a following task of the real-time application.
